(19) United States
(12) Patent Application Publication
(10) Pub. No.: US 2025/0388282 A1
(43) Pub. Date: Dec. 25, 2025

(54) APPARATUS AND METHOD FOR A BICYCLE WITH A SWING ARM

(71) Applicant: Jacob Barnes, Madison, WI (US)

(72) Inventor: Jacob Barnes, Madison, WI (US)

(21) Appl. No.: 18/750,664

(22) Filed: Jun. 21, 2024

(51) Int. Cl. B62J 7/04; B62K 25/28

(52) U.S. Cl. CPC B62J 7/04; B62K 25/28

(57) ABSTRACT

A cargo apparatus for a bicycle and the bicycle are disclosed, the bicycle comprises a seat portion, with the seat portion and a cargo portion in removable communication with the seat portion, the cargo portion comprises a cargo swing arm assembly having a cargo frame; the cargo swing arm assembly has a swing arm cargo area and a swing arm support in connection with one another, a rear wheel is rotably confined by the swing arm cargo area, a suspension system, and the cargo swing arm assembly is in the removable communication from a seat portion, and a method of applying the cargo apparatus is disclosed, with the cargo apparatus being vertically adjustable with a surface on which the cargo swing arm assembly traverses.

### FIELD

The present invention relates to the field of bicycles. The present invention more specifically relates to a two-piece bicycle comprising a swing arm frame component housing the rear wheel and an equipment storage portion.

### BACKGROUND

Bicycles have been part of society for over 200 years. It has been recognized that the first verifiable bicycle technology was the Laufmachine developed by German Baron Karl von Drais in 1817. The design provided for the first commercially successful, two-wheel, steerable, human-propelled machine. Subsequently, bicycles advanced in technology through the 19^{th} including the development of the pedal crank in 1853. Bicycle technology further advanced in the 20^{th} century with cruising bicycles and racing bicycles. Additionally, mass production of mountain bicycles began in 1981.

With that, the use of bicycles has broadened overtime. Initially bicycles were a novelty, used for enjoyment on manicured or paved streets or paths. In the 19^{th} century, bicycle use broadened to include racing. With the advent of the World Wars in the early part of the 20^{th} century, use of bicycles as a way to move personnel and equipment was placed in the forefront. During the later part of the twentieth century, use of a bicycle as a way to traverse non-manicured and non-paved roads and paths became known with the sale of bmx and mountain bicycles.

Through the advancements bicycle frames have developed into and maintained a general design. The design for which bicycle frames have employed is a single piece frame. This single piece frame includes various bicycle components, including the headtube which receives a fork for which the front wheel is attached, seat post, and top and down tubes connecting the seat post to the headtube. The combination of the headtube, seat post, and top and down tubes forms the triangle of the bicycle. In addition, the single piece frame comprises seat stays and chains stays extending from the triangle to form a connection for a rear wheel of the bicycle.

The size of each bicycle component varies dependent upon the size of the bicycle and use of the bicycle. However, the dimensional relationship of a particular component to another has remained fairly consistent. Particularly, the chain stays and seat stays have traditionally only extended a distance which allows a relatively small distance between the rear wheel and the seat post. However, analogous to the motorcycle arts, the bicycle art has provided for an extended length between the seat post and the rear wheel. However, such bicycles have been limited in that they are not designed to operate on non-manicured and non-paved roads or paths.

Suspension mechanisms have been introduced in the bicycle arts. Suspension mechanisms have been provided as part of the fork, extending in-line with the fork. Suspension mechanisms have additionally been provided as a rear suspension. The rear suspension has traditionally been positioned under the seat and operates in a direction substantially perpendicular to the seat. However, a bicycle suspension system anchored towards the rear wheel has not been provided.

With that, a swing arm mechanism is an aspect known in the motorcycle arts. In a swing arm where the frame is separated into to two parts, typically a seat portion and a rear wheel portion. The rear wheel portion adjustably connects to the seat portion. As a result, the rear wheel portion adjusts vertically to account for variations in the terrain on which the respective bicycle is moving. The swing arm in motorcycles is applied to encouraging performance of the motorcycle and limiting unsafe scenarios on the motorcycle. A swing arm type mechanism has been applied in mountain bicycles for purposes like those for motorcycles, to encourage performance. However, application for a swing arm on a bicycle has not been in conjunction with safe transport of equipment on the bicycle.

As noted, bicycles have in the past century been applied for transport of equipment. Such transport has traditionally been via a bag or a bicycle rack positioned over the rear wheel. However in both scenarios the amount of storage for transport is limited by the size of the bag hanging to the side of the bicycle or the area of the bicycle rack. However, bicycles which transport equipment are composed of single piece frames. As a result, traversing larger equipment over a non-manicured or non-paved road or path using such a bicycle has traditionally resulted in the equipment experiencing higher instability as a result of the movement. Further, bicycles having a swing arm have not been conceived as transporting equipment due to the lower probability of success of safely transporting equipment on such a bicycle over non-manicured or non-paved roads or paths.

Accordingly, there is a need for an improved bicycle comprising a mechanism which both provides for increased storage of equipment and reduced instability experienced by such equipment when traversing over non-manicured or non-paved roads or paths.

### OUTLINE OF BASIC AND OTHER ADVANTAGEOUS FEATURES

It would be desirable to provide a bicycle having charge generation devices such as solar panels on the swing arm portion.

It would be desirable to provide a bicycle having defensive shield capabilities.

It would be desirable to provide a bicycle having equipment capacity at the forks of the bicycle.

It would be desirable to provide a bicycle accommodating five inch tires.

It would be desirable to provide a bicycle capable of vertical storage.

Other advantages and/or advantageous features will become apparent to those skilled in the art, once the disclosure has been more fully shown or described. Such outlining of advantageous features is not to be construed as a limitation of applicant's disclosure but are merely aimed to suggest some of the many benefits that may be realized by the apparatus and method of the present application and with its many embodiments.

### SUMMARY

Accordingly, an apparatus for a cargo apparatus for a bicycle is disclosed. The apparatus comprises a cargo swing arm assembly. The cargo swing arm assembly may have a swing arm cargo area and a swing arm support in connection with one another. The cargo swing arm assembly may have a wheel rotably confined by the swing arm cargo area, and a suspension system. The cargo swing arm assembly may be in removable communication from a seat portion of a bicycle.

The cargo swing arm assembly and the swing arm support may be in a one piece construction. The cargo frame may extend from the swing arm cargo area. A combination of the swing arm cargo area and the cargo frame may define a storage volume for a storage of equipment. The suspension system may extend from the swing arm support to the seat portion. The suspension system may be extended from the cargo frame to the seat portion. An angle of the suspension system with respect to the cargo swing arm assembly may be less than thirty degrees. The angle of the suspension system with respect to the cargo swing arm assembly may be at least thirty degrees. A suspension system first end may be affixed to a support rib of one of the swing arm support and the cargo frame. A method of applying the cargo apparatus, wherein the cargo portion may be vertically adjustable with a surface on which the cargo swing arm assembly traverses, at a location of the removable communication.

In another aspect of the invention, a bicycle is disclosed. The bicycle comprises a seat portion, with the seat portion having a handlebar, a front tire and a seat, and a cargo portion in removable communication with the seat portion. The cargo portion comprises: a cargo swing arm assembly having a cargo frame; the cargo swing arm assembly may have a swing arm cargo area and a swing arm support in connection with one another; a rear wheel may be rotably confined by the swing arm cargo area; a suspension system; and the cargo swing arm assembly may be in the removable communication from a seat portion.

The cargo swing arm assembly and the swing arm support may be in a one piece construction. The cargo frame may extend from the swing arm cargo area. A combination of the swing arm cargo area and the cargo frame may define a storage volume for a storage of equipment. The suspension system may extend from the swing arm support to the seat portion. The suspension system may be extended from the cargo frame to the seat portion. An angle of the suspension system with respect to the cargo swing arm assembly may be less than thirty degrees. The angle of the suspension system with respect to the cargo swing arm assembly may be at least thirty degrees. A suspension system first end may be affixed to a support rib of one of the swing arm support and the cargo frame. A method of applying the cargo portion, wherein the cargo portion may be vertically adjustable with a surface on which the cargo swing arm assembly traverses, at a location of the removable communication.

These and other features and advantages of devices, methods, and systems according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a side view of a bicycle of the invention having a seat portion and a cargo portion herein.

FIG. 2 is a side view of the bicycle of the invention having the seat portion and the cargo portion herein, illustrating a two-piece construction of a bicycle frame of the bicycle.

FIG. 3 is a rear view of a first aspect of the cargo portion of the invention herein.

FIG. 4A is a side view of the bicycle of the invention, illustrating a first aspect of a suspension system position.

FIG. 4B is a side view of the cargo portion of the invention herein, illustrating the first aspect of the suspension system position and a second aspect of the suspension system position.

FIG. 5 is a side view of the bicycle of the invention herein, illustrating a third aspect of the suspension system position.

FIG. 6A is a side view of the bicycle of the invention, illustrating the second aspect of the suspension system position.

FIG. 6B is a side view of the bicycle of the invention, illustrating the second aspect of the suspension system position.

FIG. 6C is perspective view of the cargo portion of the invention herein with a first aspect of the swing arm first side, illustrating the second aspect of the suspension system position.

FIG. 6D is top view of the cargo portion of the invention herein, illustrating the second aspect of the suspension system position.

FIG. 7A is top view of the cargo portion of the invention herein, illustrating a fourth aspect of the suspension system position.

FIG. 7B is focused perspective view of a second aspect of the swing arm first side of the cargo portion of the invention herein, illustrating the fourth aspect of the suspension system position.

FIG. 7C is side view of a second aspect of the swing arm first side of the cargo portion of the invention herein.

FIG. 7D is side view of a third aspect of the swing arm first side of the cargo portion of the invention herein.

FIG. 8A is a side view of the bicycle of the invention having a seat portion, illustrating a second aspect of the cargo portion herein.

FIG. 8B is a perspective view of the second aspect of the cargo portion herein.

FIG. 8C is a top view of the second aspect of the cargo portion herein.

FIG. 9A a side view of the bicycle of the invention, illustrating application of a second aspect of the tires.

FIG. 9B a rear of the bicycle of the invention, illustrating application of the second aspect of the tires.

FIG. 10A a side view of the bicycle of the invention, illustrating application of a storage bag on fork arms.

FIG. 10B a side view of the bicycle of the invention, illustrating application of a ballistic shield.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiment illustrated herein.

Within the scope of this application, it is expressly intended that the various aspects, embodiments, examples, and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

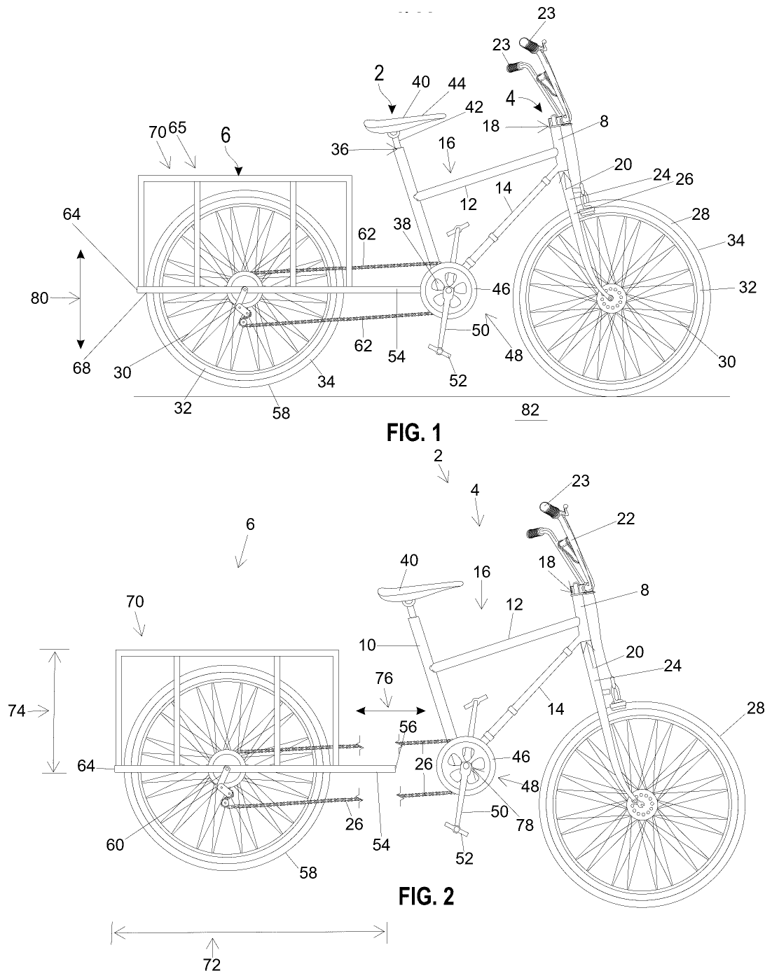

With attention to FIG. 1, side view of a bicycle 2 of the invention having a seat portion 4 and a cargo portion 6 is illustrated. The bicycle 2 has a two-piece construction. In the two-piece construction, bicycle 2 the seat portion 4 and cargo portion 6 comprise the two-pieces of the two-piece construction. The seat portion includes a headtube 8, a seat post 10, a top tube 12, and a down tube 14. The headtube 8 and the seat tube 10 are positioned opposite one another and substantially parallel to one another. The top tube 12 and the down tube 14 are each positioned between the headtube 8 and the seat tube 10. With a first end of each of the top tube 12 and the down tube 14 contacting the headtube 8. Further, a second end of each of the top tube 12 and the down tube 14 contacting the seat tube 10. The headtube 8, seat tube 10, top tube 12, and down tube 14 are fixed to one another as previously described via a weld (e.g. MIG, TIG, or stick weld). The fixed relationship of the headtube 8, seat tube 10, top tube 12, and down tube 14 provides for the triangle frame 16 of the seat portion 4.

The headtube 8 comprises a first headtube end 18, which is a top end. Further, the headtube 8 comprises a second headtube end 20, opposite the first headtube end with a body of the headtube positioned between the respective ends (18, 20). A handlebar assembly 22 is positioned on or partially inserted into the first headtube end 18. The handlebar assembly 22 comprises handlebars 23 with extend away from the first headtube end 18 in any manner known or unknown in the art. A fork assembly 24 is positioned is contact with, or inserted within, the second headtube end 20. As is known in the art, the fork assembly 24 may comprise a single or a pair of fork arms 26 which extend away from the headtube 8 and the steering assembly 22. A front wheel assembly 28 is positioned proximate the fork arms 26 and is in rotational communication with the fork arms 26. As is known in the art, the front wheel assembly 28 comprises multiple radially extending spokes 30 which extend from a central location of the wheel assembly 28. The spokes 30 extend radially from the central location in substantially all directions and along substantially the same plane. Each spoke 30 contacts the tire rim 32, where the tire rim circumferentially surrounds the central portion. A tire 34 is positioned about the rim 32, in substantially the same plane as that of the extension of the spokes 30. The tire 34 is positioned opposite the spokes 30 with respect to the rim 32. As is known in the art, a rotation of the handlebars 23 in a manner circumferentially about the first headtube end 18 results in a corresponding rotation of the fork arms 26 of the fork assembly 24. The rotation of the fork arm assembly 24 causes the fork arms 26 to corresponding rotate. As result, an angle of the wheel with respect to the triangle frame 16 is changed. This change in angle provides for a change in a direction of the bicycle.

The seat tube 10 comprises a first seat tube end 36, top seat tube end, and an opposite second seat tube end 38. A body of the seat tube is positioned between the first seat tube end 36 and the second seat tube end 38. A seat assembly 40 extends from the first seat tube end 36, as is known in the art. The seat assembly comprises a seat post 42 and seat 44. The seat post 42 moves in and out of the first seat tube end 36 with the seat 44 positioned at an end of the seat post 42. Thus, the height of the seat is adjustable as known in the art.

A drive train main gear assembly 46 of the drivetrain 48 of the bicycle is partially positioned proximate to the seat tube second end 38 and/or the down tube 14. The drive train main gear assembly 46 comprises at least one gear sprocket (not illustrated in the figure) and opposing crank arms 50 with pedals 52. The crank arms 50 are mechanically and rotationally attached to the at least one gear sprocket. A pedal 52 is attached to each crank arm 50 distal with respect to the at least one gear sprocket. As is known in the art, a rotation of the pedals 52 provides for rotation of the corresponding crank arm, which provides for rotation of an engaged gear sprocket of the at least one gear sprocket.

With attention to FIGS. 1 to 3, the bicycle 2 of the invention having the seat portion 4 and the cargo portion 6 is further illustrated. The cargo portion 6 comprises a cargo portion swing arm assembly 54. The cargo portion swing arm assembly 54 extends from a swing arm first side 56 away from the seat portion 4 and in the direction of a rear wheel assembly 58. It is observed the rear wheel assembly 58 has at least one limitation of the front wheel assembly 28. Further, it is understood the rear wheel assembly 58 comprises a drive train rear gear assembly 60. As is known in the art, the drive train main gear assembly 46 and the drive train rear gear assembly 60 are in motive connection with a bicycle chain 62, and the rotation of the at least one gear sprocket advances the bicycle chain 62. The advancement of the bicycle chain rotates at least one rear gear sprocket (not illustrated in the figures). The rotation of the rear gear sprocket rotates the rear wheel assembly 58. The rotation of the rear wheel assembly 58 advances the bicycle 2, as is known in the art.

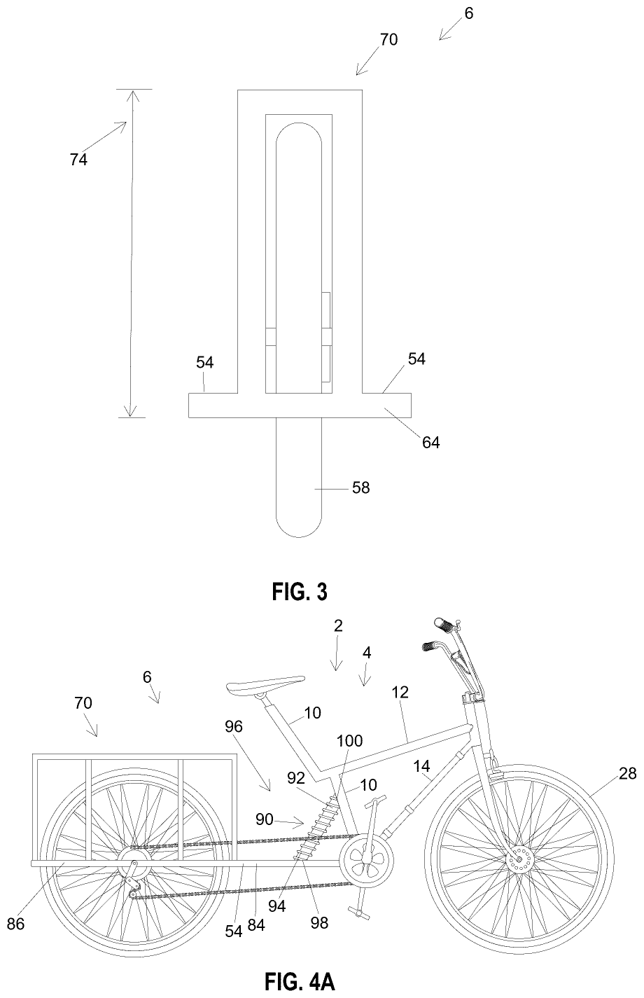

With that, the cargo portion swing arm assembly 54 extends from the swing arm first side 56 to a second swing arm side 64. The second swing arm side 64 is distal with respect to the first swing arm side 56 with the cargo portion body 65 positioned between the respective sides. The second swing arm side 64 may be positioned proximate to a circumferential edge 68 of the rear wheel assembly 58 where the circumferential edge 68 is positioned away from the seat portion 4 as compared to other components, as previously provided, of the rear wheel assembly 58. A cargo frame 70 extends from a portion of the cargo portion swing arm assembly 54 such the cargo frame 70 extends a swing arm length 72 greater than a diameter of the rear wheel assembly 58 along the extension of the cargo portion swing arm assembly 54. Alternatively, the cargo frame 68 extends a swing arm length 72 less than or substantially equal to the diameter of the rear wheel assembly 58 along the extension of the cargo portion swing arm assembly 54. Further the cargo frame 68 extends a cargo height 74 above the cargo portion swing arm assembly 54. As illustrated in FIG. 3, the cargo frame 70 may extend above the rear wheel assembly 58. Alternatively, the cargo frame 70 may extend to a height 74 proximate to the rear wheel assembly 58. FIG. 3 further illustrates the cargo portion swing arm assembly 54 may extend substantially from the rear wheel assembly 58 in order to accommodate larger equipment or additional equipment as compared to that able to be carried by the prior art.

With that, the two-piece construction of the bicycle 2 is illustrated. The cargo portion 6 is removably attached to the seat portion 4 of the bicycle 2. The removable feature allows for the rear cargo portion 6 to be attached to the seat portion 4, 76. Additionally, the rear cargo portion 6 may be detached from the seat portion 4. The attachment/detachment location 78 is proximate to at least one of second seat tube end 38 and the down tube 14. The cargo portion 6 is attached to the seat portion through a mechanical attachment. The mechanical attachment may be a bolt assembly or a tongue and groove assembly, or a combination thereof.

The removable attachment allows for vertical adjustment of the cargo section 6, 80. Where the bicycle 2 traverses uneven surfaces 82, the swing arm attachment as described allows for the cargo portion 6 to advance up and down, 80, in conformance with the surface 82. In the prior art, single piece bicycle frames are provided. Thus, in the prior art objects carried by a prior art bicycle experience direct impact of the forces resulting from the prior art bicycle contacting uneven surfaces. However, when the bicycle 2 traverses non-manicured and non-paved roads and paths 82, the removable swing arm attachment of the cargo portion 6 negates up and down following the contours of the uneven surface 82. The cargo portion 6 absorbs the forces, or substantial aspects of the forces, resulting when the bicycle 2 contacts uneven surfaces of the non-manicured and non-paved roads and paths 82. As a result, the equipment housed in the cargo portion 6 moves vertically with the vertical motion of the cargo portion 6. Thus, the equipment absorbs a reduced amount of forces as compared to equipment housed in bicycles of the prior art. Such an application poses benefits not anticipated for cargo transfer as evident from the prior art.

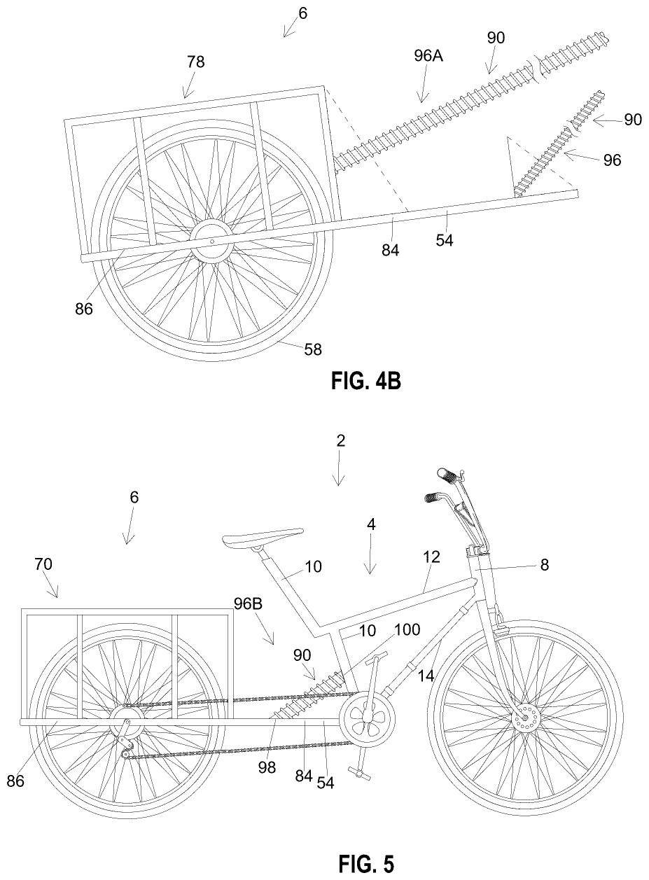

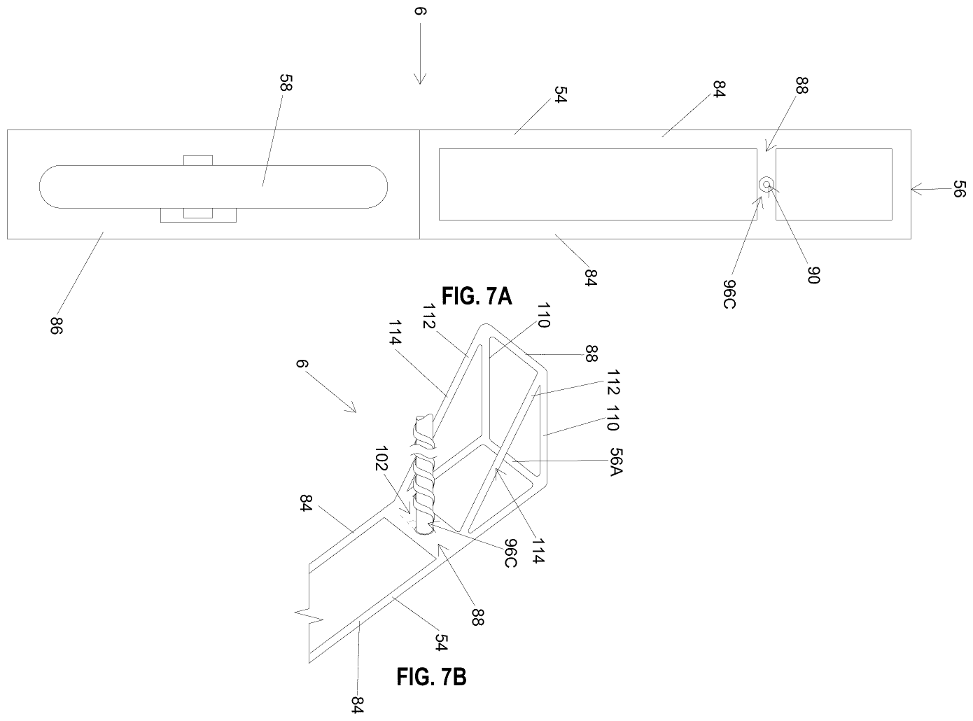

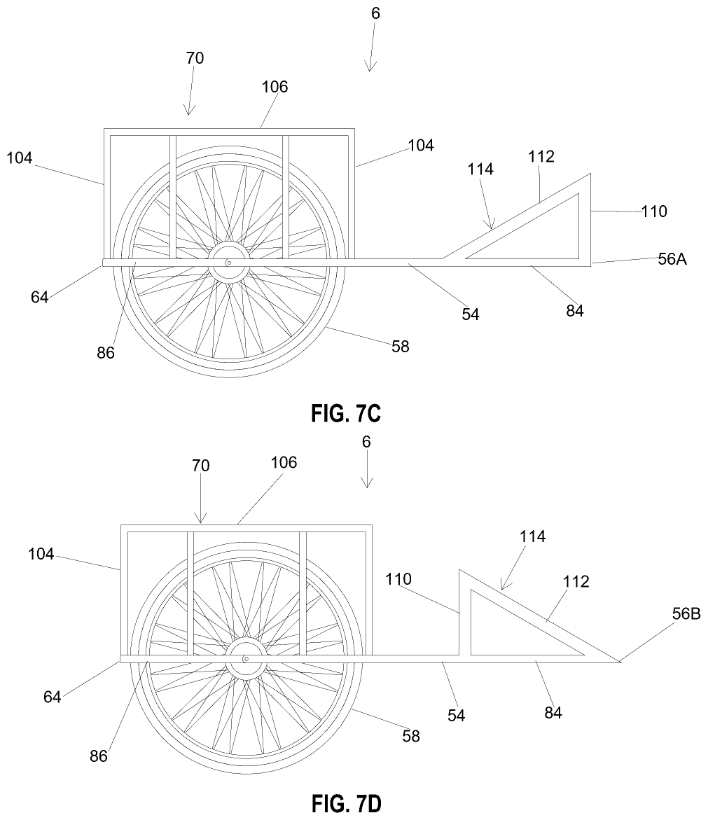

With attention to FIGS. 4A and 7A, a construction of the cargo portion 6 is further illustrated. The cargo portion swing arm assembly 54 extends as previously described. With that the cargo portion swing arm assembly 54 comprises swing arm front supports 84 and a swing arm cargo area 86. The swing arm front supports 84 extend at least substantially parallel to one another from the swing arm first side 56 to the swing arm cargo area 86. The swing arm front supports 84 are substantially planar with respect to one another. The swing arm front supports 84 are spaced a predetermined distance apart from the swing arm first side 56 to the swing arm cargo area 86. At least one front support rib 88 extends between the swing arm front support 84 and is welded or mechanically attached to the respective swing arm front supports 84.

With attention to FIGS. 4A to 7B and 8A to 8C, the bicycle 2 incorporates a suspension system 90. Preferably the suspension system is a hydraulic or pneumatic piston 92 with a coiled metal spring 94 surrounding the piston along the long axis of the piston 92. Alternatively, the suspension system 90 may comprise the hydraulic or pneumatic piston 92. Alternatively, the suspension system 90 may comprise the coiled metal spring 88. The suspension system 90 provides additional support to equipment carried by the bicycle 2, complementing two-piece swivel arm construction on the bicycle 2. The suspension system 90 allows for the vertical adjustment 80 of the cargo portion 6, resulting from the cargo portion 6 moving vertically as a swing arm, when the bicycle 2 engages non-manicured and non-paved roads and paths 82. Simultaneously, the suspension system 90 gradually decelerates the rate of the vertical adjustment 80 of the cargo portion 6. This gradual deceleration additionally cushions the equipment stored in the cargo portion 6 from the forces experienced on the bicycle 6. Subsequently, the suspension system 84 provides for a gradual and controlled return to at least proximately an original position of the cargo portion 6 with respect to the seat portion 4. A gradual and controlled return for the purposes of this application means a rate of return slower than the prior art which lacks such a suspension for cushioning a cargo portion of the prior art bicycle.

With attention to FIGS. 4A and 4B, a first aspect of a suspension system position 96 is illustrated. In the first aspect of the position 96 a suspension system first end 98 is affixed to the cargo portion swing arm assembly 54. Specifically, the suspension system first end 98 may be affixed to one of the swing arm front supports 84. Preferably, the suspension system first end 98 is affixed to the at least one front support rib 88, see FIG. 7A. A suspension system second end 100 is affixed to the seat tube 10. The angle 102 of the suspension system 90 with respect to the cargo portion swing arm assembly 54, specifically the swing arm front supports 84, is greater than 30 degrees. This high angle of the suspension system 90 allows for an increased reduction in the vertical advancement 80 of the cargo portion 6. It is observed FIG. 4B additionally illustrates a second aspect of the suspension system position 96A.

With attention to FIG. 5, a third aspect of the suspension system position 96B is illustrated. In the third aspect of the position 96B the suspension system first end 98 is affixed to the cargo portion swing arm assembly 54. Specifically, the suspension system first end 98 may be affixed to one of the swing arm front supports 84. Preferably, the suspension system first end 98 is affixed to the at least one front support rib 88, see FIG. 7A. The suspension system second end 100 is affixed to the seat tube 10. The angle 102 of the suspension system 90 with respect to the cargo portion swing arm assembly 54, specifically the swing arm front supports 84, is less than or equal to 30 degrees. This low angle of the suspension system 90 allows for a reduction in the vertical advancement 80, see FIG. 1, of the cargo portion 6. This lower angle 102 as compared to that of the first position 96 provides for the third position accommodating a more gradual response to variations in non-manicured and non-paved roads and paths 82, see FIG. 1.

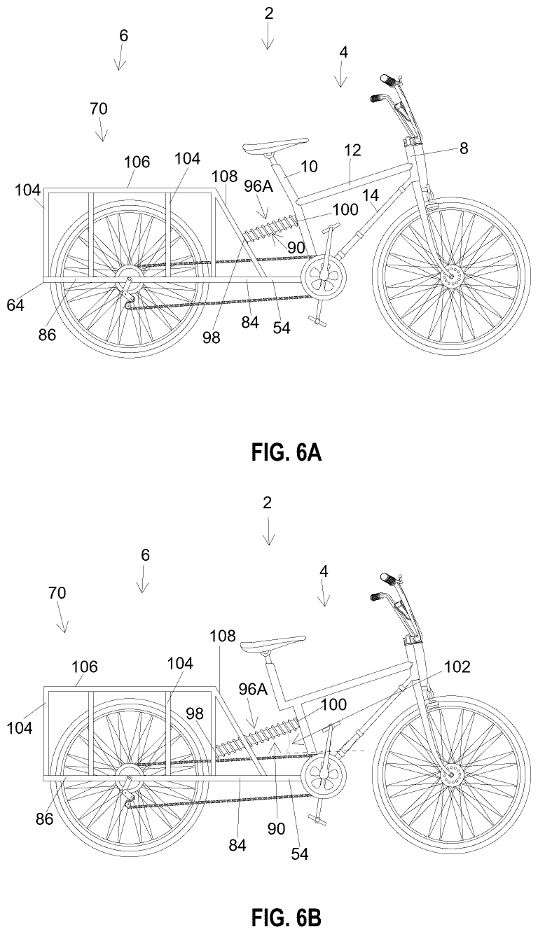

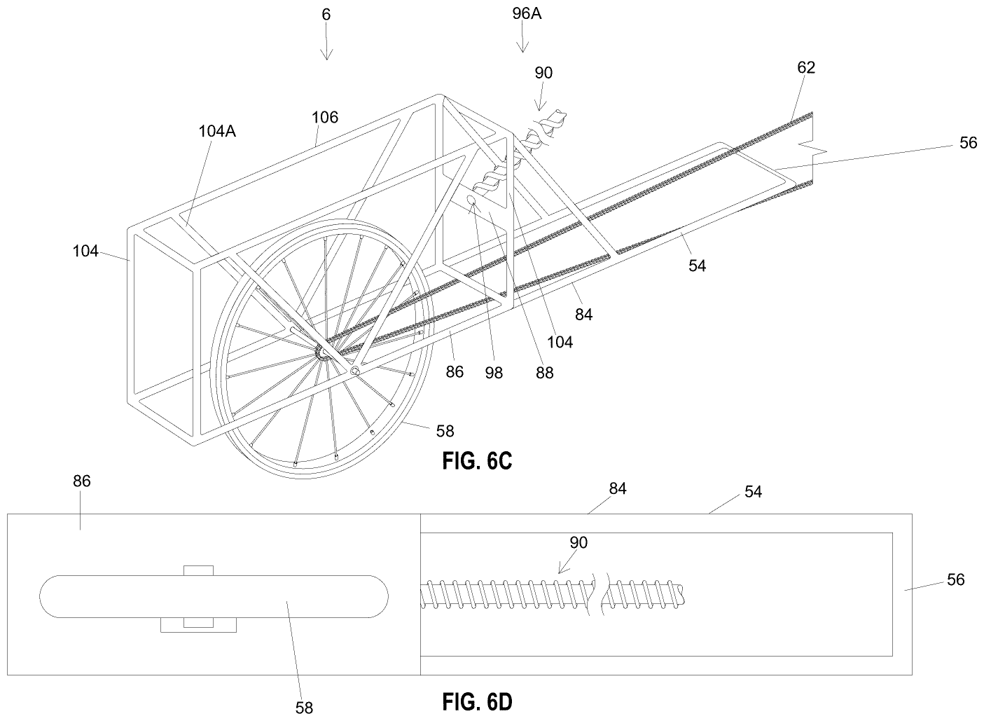

With attention to FIGS. 4B, and 6A to 6D, the second aspect of the suspension system position 96A is illustrated. With that, the cargo frame 70 comprises a predetermined number of at least substantially vertical extensions 104 are attached to at least one of the swing arm cargo area 86 and cargo portion swing arm assembly 54. The extensions 104 are positioned so as to extend above the rear wheel assembly 58 on either side of the rear wheel assembly 58. A connection member 106 mechanically connects the vertical extensions 104 to provide for a semi-closed area. Is understood the vertical members may be wrapped with a cloth, plastic or metal to provide for a substantially closed volume for the transporting equipment. Further, an angular extension 108 may be positioned between the connection member 106, or the vertical extension 104 most proximal to the seat tube 10, and a location along one of the swing arm front supports 84 or a location along the cargo portion swing arm assembly 54.

In the second aspect of the position 96A, the suspension system first end 98 may be positioned along one of the angular extensions 108 or a front support rib 88, see FIG. 7A, extend between and affix to both angular extensions, see FIG. 6A. As illustrated in FIGS. 4B, 6B, 6C, and 6D, the suspension system first end 98 may be affixed to a front support rib 88, see FIG. 7A extending between and affixed to the vertical members most proximate to the seat tube 10. The suspension system second end 100 is connected to the seat tube 10. In both examples of the second aspect of the position 96A, the angle 102 is less than or equal to 30 degrees. This low angle of the suspension system 90 allows for a reduction in the vertical advancement 80, see FIG. 1, of the cargo portion 6. This lower angle 102 as compared to that of the first position 96, see FIG. 4A, provides for the second position 96A accommodating a more gradual response to variations in non-manicured and non-paved roads and paths 82, see FIG. 1. As Illustrated in FIG. 6C, the vertical extensions 104 may be angular in nature 104A, angular extensions. The angular extensions 104A on a respective side of the rear wheel assembly 58 may each extend from a central location on the swing arm cargo area 86 to locations on the connection member 106. The angular extensions provide for storage for equipment at a reduced weight for the cargo portion 6.

With attention to FIGS. 7A and 7B, a fourth aspect of the suspension system position 96C is illustrated. In the fourth aspect 96C, the suspension system first end 98 is affixed to the at least one front support rib 88 positioned between and affixed to the substantially parallel swing arm front supports 84. The suspension system second end 100, see FIG. 6B, is affixed to the seat tube 10. The angle 102 of the suspension system 90 with respect to the cargo portion swing arm assembly 54, specifically the swing arm front supports 84, is substantially 90 degrees. This high angle of the suspension system 90 allows for an increased reduction in the vertical advancement 80, see FIG. 1, of the cargo portion 6.

With attention to FIGS. 7B and 7C, a second aspect of the swing arm first side 56A of the cargo portion 6 is illustrated. The second aspect of the swing arm first side 56A comprises a substantially vertical first side member 110 extending from the first side 56A substantially planar to one of the swing arm front supports 84. An angular first side member 112 extends from the substantially vertical first side member 110 at an end of such member that is opposite the swing arm support 84. The angular first side member 112 advances towards and affixes to the respective swing arm front supports 84. As a result a triangular structure 114 is created at the swing arm first side 56A a top of each swing arm front supports 84. The triangular structures 114 are connected by a support rib 88 connected to each triangular structure 114. The second aspect of the swing arm first side 56A is attached to the seat portion 4 about the drive train main gear assembly 46. Thus, the second aspect of the swing arm first side 56A of the cargo portion 6 allows for an increased range of vertical adjustment 80 as compared to the prior art.

With attention, to FIG. 7D, a third aspect of the swing arm first side 56B of the cargo portion 6 of the invention is illustrated. The third aspect of the swing arm first side 56B comprises a substantially vertical first side member 110 extends from a respective swing arm support 84 at a distance from the first side 56B and substantially planar to the respective swing arm front support 84. An angular first side member 112 extends from the substantially vertical first side member 110 at an end of such member that is opposite the swing arm support 84. The angular first side member 112 advances towards and affixes at least proximate to the first side 56B. As a result a triangular structure 114 is created at the swing arm first side 56B a top of each swing arm front supports 84. The triangular structures 114 are connected by a support rib 88 connected to each triangular structure 114. The third aspect of the swing arm first side 56B is attached to the seat portion 4 about the drive train main gear assembly 46. Thus, the third aspect of the swing arm first side 56B of the cargo portion 6 allows for an increased range of vertical adjustment 80 as compared to the prior art. In addition the third aspect of the first side 56B allows for ease of connection of the cargo portion 6 and the seat portion 4, see FIG. 1.

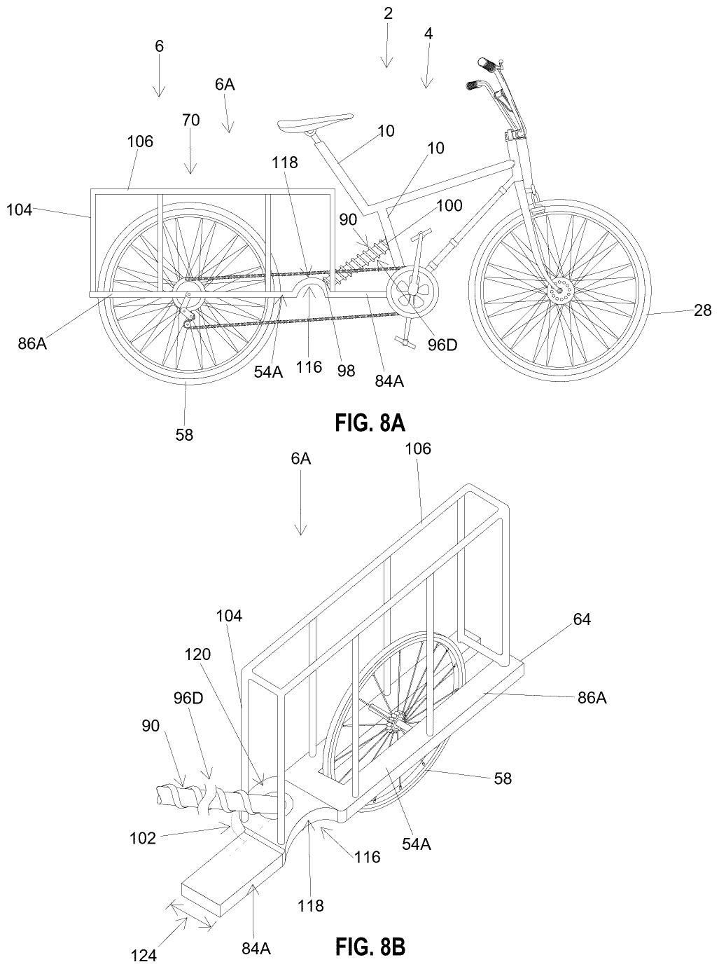

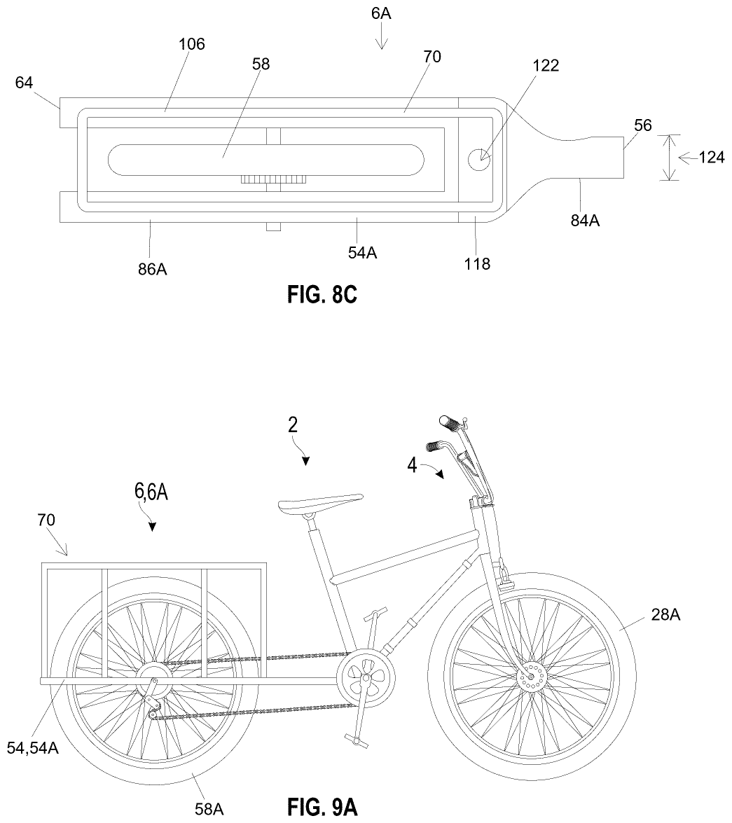

With attention to FIGS. 8A to 8C, the bicycle 2 of the invention comprising a second aspect of the cargo portion 2A is illustrated. The second aspect of the of the cargo portion 2A shares at least one limitation with the first aspect of the cargo portion 2. The cargo portion 2A comprises a second aspect of the cargo portion swing arm assembly 54A in communication with the cargo frame 70. The second aspect of the cargo portion swing arm assembly 54A comprises a second aspect of the swing arm cargo area 86A and a second aspect of the swing arm front support 84A. The second aspect of the swing arm cargo area 86A is a plate structure. A first end 116 of the swing arm cargo area 86A the plate structure provides for an arc 118 in the plate structure. The arc preferably rises in the direction of the connection member 116. The arc 118 alternatively may yield in a direction opposite the connection member.

The suspension system first end 98 is positioned proximate to an apex 120 of the arc 118. The suspension system second end 100, see FIG. 6A, is affixed to the seat portion 4 as previously described. The angle 102 of incline of the suspension system 98 from the arc 118 may be a low angle, less than 30 degrees, as previously described. Alternatively, the angle 102 of incline of the suspension system 98 from the arc 118 may be a high angle, greater than or equal to 30 degrees, as previously described. The angle 102 depends upon, among other things, the location of the positioning 122 of the suspension system first end 98 on the arc 118 and the distance between the suspension system first end 98 and the seat portion 4.

The swing arm front support 84A comprises a single piece extension from the arc, in the direction of the seat portion 4. The swing arm front support 84A may comprise a substantially constant arm width 124. Alternatively, the swing arm front support 84A may comprise a tapered arm width 124, tapering from the arc 118 to the swing arc first side 56. The single piece extension of the swing arm front support 84A allows for the first side 56 to be affixed to the seat portion 4. The connection of the first side 56 to the seat portion 4 is as previously described for the connection of the cargo portion 6 to the seat portion 4. Additionally the swing arm front support 84A may allow for lateral rotation of the cargo portion 6 during movement of the bicycle 2.

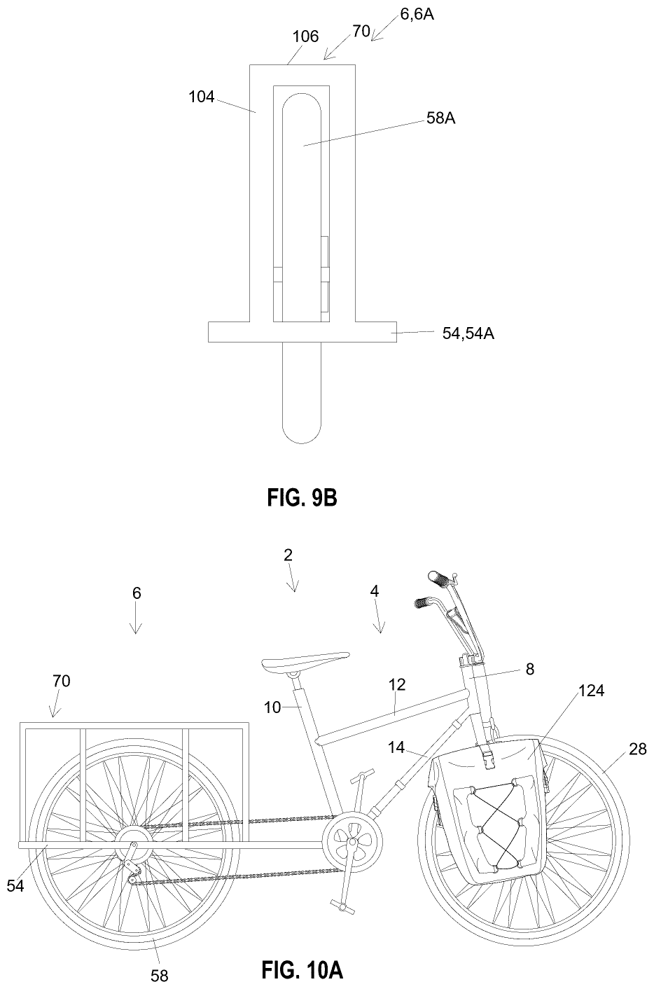

With attention to FIGS. 9A to 9B, the bicycle 2 of the invention is illustrated employing a second aspect of the tires (28A, 58A). The second aspect of the tires (28A, 58A) are wide width tires. As is known, wide width tires, e.g. 5 inch width tires, are applied to traverse loose surfaces, e.g. sand, mud, surfaces with loose covering. The use of the second aspect of the tires (28A, 58A) further cushions the equipment stored on the bicycle 2 during transport of the equipment.

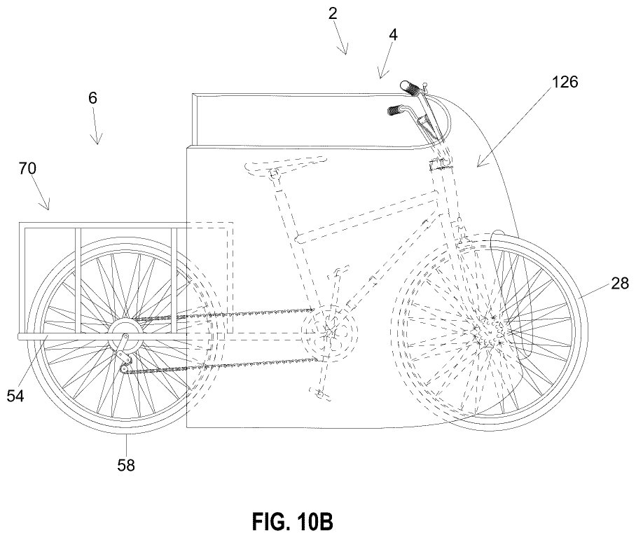

With attention to FIG. 10A, the bicycle 2 of the invention is illustrated with a storage bag on a respective fork arm 26. The use of the storage bag 124 allows for additional movement of equipment. Further the use of suspension systems 90 as part of the fork 26 (not illustrated in the figures) allows for added cushioning of such equipment while housed in the storage bag.

With attention to FIG. 10B, the bicycle 2 of the invention is illustrated with application of a ballistic shield 126. The ballistic shield 126 provides for protection of the operator of the bicycle 2. Such a protection is applicable in conflict areas, law enforcement operations, or other security related operations. The ballistic shield comprises known ballistic material in the art, and may be an origami ballistic shield.

The apparatus, and method of applying the apparatus, addresses a need for an improved bicycle 2 comprising a mechanism which both provides for increased storage of equipment and reduced instability experienced by such equipment when traversing over non-manicured or non-paved roads or paths. The bicycle 2 comprises a seat portion 4 and cargo portion 6 affixed to one another. The attachment of the seat portion 4 and the cargo portion 6 is provided by a swivel arm mechanism allowing the cargo portion to act as a swivel arm. Further, the use of a suspension system 90 is applied between the cargo portion and a seat tube 10 of the seat portion 4. The swivel arm motion of the cargo portion 6 in conjunction with the suspension system 90 provides for a reduced force on equipment stored on the bicycle 2 while traversing the equipment.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A cargo apparatus for a bicycle, comprising:
a cargo swing arm assembly;
the cargo swing arm assembly having a swing arm cargo area and a swing arm support in connection with one another, and a cargo frame;
a wheel rotably confined by the swing arm cargo area;
a suspension system; and
the cargo swing arm assembly in removable communication from a seat portion of a bicycle.

2. The cargo apparatus of claim 1, wherein the cargo swing arm assembly and the swing arm support are in a one piece construction.

3. The cargo apparatus of claim 1, wherein the cargo frame extends from the swing arm cargo area.

4. The cargo apparatus of claim 3, wherein a combination of the swing arm cargo area and the cargo frame define a storage volume for equipment.

5. The cargo apparatus of claim 1, wherein the suspension system is extended from the swing arm support to the seat portion.

6. The cargo apparatus of claim 1, where in the suspension system is extended from the cargo frame to the seat portion.

7. The cargo apparatus of claim 1, wherein an angle of the suspension system with respect to the cargo swing arm assembly is less than thirty degrees.

8. The cargo apparatus of claim 7, wherein the angle of the suspension system with respect to the cargo swing arm assembly is at least thirty degrees.

9. The cargo apparatus of claim 1, wherein a suspension system first end is affixed to a support rib of one of the swing arm support and the cargo frame.

10. A method of applying the cargo apparatus of claim 1, wherein the cargo portion is vertically adjustable with a surface on which the cargo swing arm assembly traverses, at a location of the removable communication.

11. A bicycle, comprising:
a seat portion, with the seat portion having a handlebar, a front tire and a seat;
a cargo portion in removable communication with the seat portion; and
the cargo portion comprising:
a cargo swing arm assembly;
the cargo swing arm assembly having a swing arm cargo area and a swing arm support in connection with one another, and a cargo frame;
a rear wheel rotably confined by the swing arm cargo area;
a suspension system; and
the cargo swing arm assembly in the removable communication from a seat portion.

12. The bicycle of claim 11, wherein the cargo swing arm assembly and the swing arm support are in a one piece construction.

13. The bicycle of claim 11, wherein the cargo frame extends from the swing arm cargo area.

14. The bicycle of claim 13, wherein a combination of the swing arm cargo area and the cargo frame define a storage volume for a storage of equipment.

15. The bicycle of claim 11, wherein the suspension system is extended from the swing arm support to the seat portion.

16. The bicycle of claim 11, where in the suspension system is extended from the cargo frame to the seat portion.

17. The bicycle of claim 11, wherein an angle of the suspension system with respect to the cargo swing arm assembly is less than thirty degrees.

18. The bicycle of claim 17, wherein the angle of the suspension system with respect to the cargo swing arm assembly is at least thirty degrees.

19. The bicycle of claim 11, wherein a suspension system first end is affixed to a support rib of one of the swing arm support and the cargo frame.

20. A method of applying the cargo portion of claim 11, wherein the cargo portion is vertically adjustable with a surface on which the cargo swing arm assembly traverses, at a location of the removable communication.
